(19) United States
(12) Patent Application Publication
(10) Pub. No.: US 2024/0201101 A1
(43) Pub. Date: Jun. 20, 2024

(54) Method and apparatus for inspecting containers and determining a rotational position of a container closure

(71) Applicant: KRONES AG, Neutraubling (DE)

(72) Inventor: Stefan PIANA, Koefering (DE)

(21) Appl. No.: 18/287,163

(22) PCT Filed: Mar. 23, 2022
(86) PCT No.: PCT/EP2022/057699

§ 371 Date: Oct. 16, 2023

(30) Foreign Application Priority Data
Apr. 14, 2021 (DE) 10 2021 109 286.8

(51) Int. Cl. G01N 21/90

(52) U.S. Cl. CPC G01N 21/90

(57) ABSTRACT

Provided is a method for inspecting containers, wherein containers provided with container closures are transported a transport device along a predetermined transport path and inspected a first inspection device during this transport, wherein the inspection device captures at least one first image of at least the container closure of a container an image capture device, and
a second image of at least this container closure is captured by an image capture device, wherein a time interval between the capture of the first image and of the second image preferably is less than 10 ms.

### BACKGROUND OF THE INVENTION

The present invention relates to a method and an apparatus for inspecting containers, in particular beverage containers. It has long been known from the prior art in the sector of the beverage producing industry to inspect containers. For example, it is known to inspect the containers for damage or for contamination.

In addition, it is known in the prior art to carry out tests on closed containers to determine whether a closure is properly arranged on each container. For this purpose, methods and apparatuses are known from the prior art, in which a rotational position of a container closure relative to the opening region of the container is checked or determined, in particular in containers which are manufactured from PET. This is done in some cases by means of markings provided both on the container closure and on the container itself.

Corresponding apparatuses and methods have proven successful in the prior art. Nevertheless, problems may occur if, for example, contamination or liquid droplets are located on the container closures.

A method for inspecting containers is known from EP 1 270 433 A2. In this case, an image of a container mark and a closure mark is captured and the image is transmitted to a processing device in order to analyze a position of these markings.

WO 2014/023580 describes a seal inspection apparatus in which likewise a distance between a mark on a container and a mark on the closure is determined. WO 2019/025956 A1 describes an apparatus and a method for determining an angular position of a closure relative to a bottle.

In the prior art, it is routine practice, for example, to remove contamination such as remaining droplets of water. However, water droplets remaining despite a blow-off action can also make it much more difficult to identify the angle features on the closure and on the container (for example on a support ring), which thus also makes inspection more difficult.

### SUMMARY OF THE INVENTION

In a method according to the invention for inspecting containers and in particular containers provided with container closures, the containers are transported by means of a transport device along a predetermined transport path and inspected by means of a first inspection device during this transport, wherein the inspection device captures a first image of at least the container closure of a specific container (but preferably also of an opening region of the container) by means of an image capture device.

According to the invention, a second image of at least this container closure is captured by means of an image capture device. In this case, a time interval between the capture of the first image and the capture of the second image is preferably less than 100 ms, preferably less than 50 ms, preferably less than 20 ms, preferably less than 10 ms, preferably less than 8 ms, preferably less than 6 ms, preferably less than 5 ms and preferably less than 3 ms.

Preferably, the containers are inspected while they move and, in particular, at least one image and preferably both images are captured while the containers are moving. Preferably, the containers are transported at a transport speed that is greater than 0.1 m/s, preferably greater than 0.3 m/s, preferably greater than 0.5 m/s, preferably greater than 0.8 m/s and particularly preferably greater than 1.0 m/s. Preferably, the containers are transported at a transport speed that is less than 20 m/s, preferably less than 15 m/s, preferably less than 10 m/s, preferably less than 8 m/s, preferably less than 6 m/s, preferably less than 5 m/s, preferably less than 3 m/s, preferably less than 2.5 m/s.

It is therefore proposed that at least two and preferably exactly two images of the same container closure are captured. It is possible in this case for these two images to be carried out by means of the same image capture device or camera. In the process, contamination such as water droplets are identified on the basis of different images during image processing and can preferably be ignored, whereas the alignment features are imaged similarly and can be distinguished unambiguously from water droplets.

Preferably, the first image and the second image or the at least two captured images of the same container are compared with one another and/or both images are evaluated. In addition to capturing images, it would also be possible to capture image sequences. Preferably, this comparison between the images is used to infer the presence of foreign bodies such as liquid droplets.

Preferably, this comparison of the two images distinguishes between features (or markings of the closure or container) that are or are to be searched for and interfering artifacts (such as those caused by water droplets).

Unlike in the prior art, the two image captures are therefore not carried out in order to be able to better identify particular markings, but to be able, from these two image captures, to make a distinction between the markings and artifacts in the image representation.

In a further advantageous method, the first and the second image are captured by means of the same image capture device. In this case, it is possible for this image capture device to be triggered and/or to capture a corresponding image twice successively at short intervals. However, it would also be possible to provide two cameras which are preferably directed at the same region of the container or the closure thereof.

Preferably, the same or substantially the same image field (and/or the same container) is captured by the two image captures (apart from a small offset resulting from the movement of the container).

However, the illumination parameters are preferably changed in the two image captures.

The images are preferably captured or triggered at effectively the same location (of the container) and preferably in short succession. This means that the time interval between the captures of the two images is so small that the location of the container between the time of the first image capture and the time of the second image capture has not changed or has not changed significantly.

In the period between the capture of the first image and the capture of the second image, the container moves preferably by less than 3 cm, preferably by less than 2 cm, preferably by less than 1.5 cm, preferably by less than 1 cm, preferably by less than 0.8 cm, preferably by less than 0.6 cm and particularly preferably by less than 0.5 cm. However, it would also be conceivable for at least one image or both images to be captured while the containers are at a standstill.

A time interval between the two captures is preferably less than 1 s, preferably less than 0.5 s, preferably less than 0.2 s, preferably less than 0.1 s, preferably less than 50 ms, preferably less than 10 ms, preferably less than 8 ms, preferably less than 6 ms, preferably less than 5 ms, preferably less than 3 ms, preferably less than 2 ms, preferably less than 1 ms, preferably less than 0.5 ms. The time interval is preferably greater than 0.01 ms, preferably greater than 0.02 ms, preferably greater than 0.03 ms, preferably greater than 0.04 ms and particularly preferably greater than 0.05 ms.

Due to these short time intervals, the container can be captured twice at the (substantially) same location in spite of a specific finite transport speed. If, for example, the container is moved at a speed of 2 m/second, this would mean, for example, at a time interval between two captures of 0.5 milliseconds, that the container has moved only by 1 mm.

Preferably, two spatially identical images are captured. This means that the two images are captured by the same region of a system; only the container has moved slightly between the first capture and the second capture. However, at least the container closure and/or the opening region of the container is preferably reproduced fully on both images.

The inspected containers are particularly preferably containers which have heights between 50 mm and 800 mm, preferably between 100 mm and 400 mm. Preferably, the inspection method is carried out at a production capacity of up to 90,000 containers/h. Particularly preferably, the containers are plastic containers and in particular plastic bottles.

In a further preferred method, the containers are transported along a rectilinear, in particular single-track, transport path. However, it would also be possible for the containers to be transported along a circular or circular-segment-shaped transport path. In this case, the containers can be transported, for example, by means of a transport belt. In addition, however, it would also be conceivable for the containers to be transported by means of lateral guide belts.

Preferably, the containers are filled and sealed containers. In a further preferred method, the image captures are triggered by means of a trigger device. The illumination times for the image captures are preferably greater than 1 μs, preferably greater than 2 μs, preferably greater than 5 μs and preferably greater than 10 μs. The illumination times are preferably less than 500 μs, preferably less than 300 μs, preferably less than 200 μs and particularly preferably less than 100 μs.

In a preferred method, at least one image of a top side of a container closure is captured. Preferably, the observation is carried out from above the container closure. In this case, it is possible and preferable for the image capture device to be arranged above the container closure, however, a deflection of the radiation path or the observation path (for example by means of mirrors) would also be conceivable. Preferably, the image capture device (during the capture of the images) is arranged substantially vertically above the containers.

In a further preferred method, the first image is captured using first physical parameters, and the second image is captured using second physical parameters, wherein at least one parameter (and in particular the value of this parameter) of the first physical parameters differing from at least one parameter (and in particular the value of this second parameter) of the second physical parameters (in particular a parameter which describes the same physical property) and/or wherein these parameters deviating from one another at least in part. In particular, the two captures differ from one another in at least one parameter.

For example, the first image can be captured with a specific set (p1, p2, p3, p4) of parameters and the second image with a further set (q1, q2, q3, q4) of parameters, and the following can apply: p1=q1, p2=q2, p3=q3, and p4 is not equal to q4.

In a preferred method, said physical parameter is selected from a group of parameters which contains a time of the image capture, a duration of the image capture (or an illumination time), a color or a spectral range of illumination, an illumination type, a filter setting (optionally also of a software filter), an observation angle of the image capture device, a distance of the observation device from the container closure, an illumination direction of illuminating radiation, a polarization of illuminating radiation, a directivity of the illuminating radiation, and the like. It would also be possible for several such physical parameters to deviate from one another.

However, when a double trigger is used, that is to say two captures are carried out in quick succession by a camera, the observation angle of the image capture device and the distance of the observation device from the container closure preferably remain substantially constant.

Thus, for example, the first and the second image can differ from one another with respect to an illumination color or with respect to an illumination direction or with respect to an illumination type and the like.

In this case, the image capture device is preferably triggered twice in very quick succession at the substantially same location of the container, wherein different illumination types are applied for the two captures in this preferred method.

The illumination color or wavelength used can preferably be wavelengths from the ultraviolet range to the infrared range.

As mentioned, the light can be radiated from different directions, similar to what is referred to as the “shape from shading” method (this is an inclination-measuring and curvature-measuring 3D method which is also applied in automated quality control—particularly of inline surface inspection tasks). This makes it possible to reliably detect shape deviations such as cracks, scratches, pores or notches, in particular on flat surfaces, but optionally also the presence of foreign bodies or substances such as liquid droplets.

In addition, as mentioned, a different directivity of the light used can also be used. This can range from a hard-directional light to full-diffusion (cloudy day) illumination. As mentioned above, different polarization directions of the illuminating light can also be used.

In a further preferred method, an opening region of the container (in particular closed by the closure) is also captured with the first image and/or the second image. In particular, a marking located on the container closure is also captured with the first image. Furthermore, a marking located on a region of the container and in particular on a support ring is also captured with the first and/or the second image.

The container closures to be inspected therefore preferably have at least one marking which can be detected by an image capture device (i.e., optically). This marking can be provided, for example, in an edge region of the container closure. In a further preferred method, the container itself and, in particular, its opening region and, in particular, its support ring also have a marking which can be detected by an image capture device.

In a preferred method, the illumination parameters are selected such that the markings differ only slightly in the captured images. Preferably, the illumination parameters are selected such that foreign bodies such as water droplets differ significantly in the captured images. In this way, it is possible to determine—from a comparison between the image captures—which image feature originates from an artifact or a foreign body and which image feature is actually the reproduction of a marking.

Preferably, therefore, the two image captures are used to make a distinction between the markings (to be located) and image artifacts and/or to suppress the effects which are triggered, for example, by water droplets. In this way, detection performance can be increased. Furthermore, it would also be possible to create more than two images.

In a further preferred method, at least one of the captured images is evaluated in order to infer a rotational position of the container closure relative to the container. In this case, a corresponding evaluation can take place by means of algorithms or by using artificial intelligence.

More precisely, it is possible to detect, for example, water droplets and the alignment features by means of a conventional algorithm or else by using a neural network for the image processing. A convolutional neural network (CNN) can preferably be used. After training with suitable and high-quality annotated camera images, such a network can enable higher selectivity.

Preferably, a plurality of reference images is stored in particular in a memory device, and a comparison device is preferably provided which compares these stored images with captured images. A relative rotational position of the container closure or of the container can be determined on the basis of this comparison.

The image capture device preferably captures at least one spatially resolved image of the container closure and/or of the container. Preferably, to detect the container, the image capture device generates spatially resolved (in particular 2D and/or 3D) sensor data (from the container and/or the closure thereof).

Preferably, evaluation data are generated from the sensor data, in particular using a processor device and/or data processing device, by applying at least one (computer-implemented) computer vision method, in which (computer-implemented) perception and/or detection tasks are carried out, for example (computer-implemented) 2D and/or 3D object recognition methods and/or (computer-implemented) methods for (computer-implemented) semantic segmentation and/or (computer-implemented) object classification (image classification) and/or (computer-implemented) object localization.

In object classification, the object detected and/or displayed in the sensor data is assigned to a (previously learned and/or predetermined) class. In object localization, in particular in addition to object classification, a location of an object (for example a marking present on the closure) detected and/or displayed in the sensor data is determined (in particular in relation to the sensor data) and is marked and/or highlighted in particular by what is known as a bounding box. In semantic segmentation, in particular each pixel of the sensor data is assigned a class (for classification of an object) (in particular from a particularly predetermined plurality of classes) (class annotation).

For example, the classes can be (inter alia) contamination types (such as water and dust) or types of container closures (such as shape and color).

Preferably, the determination of the evaluation data from the (raw) data generated by the sensor device or data derived therefrom (in particular the execution of computer vision methods or perception methods) is based on (computer-implemented) machine learning methods, preferably machine learning methods based on at least one (artificial) neural network. Such a neural network can be designed, for example, as a deep neural network (DNN), preferably a so called convolutional neural network (CNN) and/or a recurrent neural network (RNN).

For evaluation, the evaluation device can be integrated into the inspection device or else into a higher-level machine control. The evaluation device, in particular intelligent evaluation device, is preferably capable of assessing a rotational position of the container closure relative to the container by means of modern algorithms (AI, i.e., artificial intelligence, machine learning, deep learning, etc.). The evaluation device preferably has a processor and/or a memory device. The evaluation device is preferably suitable and intended to make a prediction with regard to a closure state of the container.

The evaluation device can specify a classification of a closure state of the container (in particular by means of a computer program and/or with the aid of modern algorithms such as AI, machine learning and/or deep learning or the like).

The present invention is further directed to an apparatus for inspecting containers provided with container closures, comprising a transport device which transports the containers along a predetermined transport path and comprising an inspection device which is used for inspecting the containers, the inspection device having at least one first image capture device which captures at least one image of a container provided with a container closure.

According to the invention, the inspection device is suitable and intended to capture at least one second image of this container provided with the container closure.

Preferably, said image capture device captures both images. However, it would also be conceivable for two or more image capture devices to be provided.

In a further preferred embodiment, the apparatus has an illumination device for illuminating the containers and/or the container closures. It is possible for this illumination device to also be triggered. Particularly preferably, the apparatus has a trigger device for triggering an image capture. This triggering can take place at a specific position of the containers. For example, light barrier devices can be provided, which trigger the first image capture when a container has reached a particular position. The second image capture can take place at a predetermined time interval after the first image capture.

When a double trigger is used, the illumination device preferably has at least two flashing light sources, such as two flashing lamps. These are particularly preferably triggered with the image captures in a highly synchronous manner, i.e., in particular in the one-digit to two-digit us range. Therefore, at least two light sources of the illumination device are preferably triggered at a time interval with respect to one another which is less than 100 μs and/or greater than 1 μs.

Preferably, a trigger signal (from the outside) is guided to the camera system, and the camera system assumes the highly synchronous sequence control for the lamp flashes and the camera shutter.

The illumination device is preferably suitable and intended to output a pulsed illumination onto the containers. This illumination can also be triggered and/or pulsed.

In a further preferred embodiment, the at least one illumination device is arranged in such a way that it illuminates the container or the container closure obliquely. In a further advantageous embodiment, the image capture is provided substantially vertically above the container to be inspected. The image capture device is preferably arranged above the transport path of the containers. In this case, the containers are preferably transported upright or with their opening upward.

In a further preferred embodiment, the image capture device observes the containers in the longitudinal direction thereof. The distance (in particular in a longitudinal direction of the containers) between the image capture device, and/or the optical unit thereof, and the container closure is preferably greater than 4 mm, preferably greater than 6 mm, preferably greater than 8 mm, preferably greater than 10 mm, and preferably greater than 12 mm. In a further preferred embodiment, a distance between the image capture device, or the optical unit thereof, and the container closure is less than 70 mm, preferably less than 60 mm, preferably less than 50 mm, preferably less than 40 mm and preferably less than 35 mm.

Particularly preferably, a hypercentric capture is carried out. Hypercentric, i.e., pericentric, objectives are known from the prior art. These objectives can observe objects from several directions simultaneously. In the case of a container closure, such objectives allow—for example in a view from obliquely above—the closure surface and the outer surfaces (in particular of the container closure) to be captured simultaneously. A front lens of such an objective preferably has a significantly larger diameter and/or cross section than the object to be observed, i.e., than the closure and the support ring of the container in this case.

As mentioned above, the apparatus preferably has only one image capture apparatus, which is particularly preferably controlled in such a way that it carries out at least two captures of the same container and/or the same container closure (in particular during the movement thereof). The containers are preferably transported at a distance from one another.

In a preferred embodiment, the apparatus has a control device for controlling the image capture device(s). In a further preferred embodiment, the image capture device is designed to capture (in particular spatially resolved) images of the container closures using the frontlight method.

Particularly preferably, at least one lens device is arranged in the beam path between the image capture device and the container closure. An image is advantageously captured at a focal point or in the vicinity of the focal point of this lens device.

In a preferred embodiment, the container closures have a fastening element in order to fasten the container closure to the container. In this way, the container closure remains on the container even after the container closure has been opened. In a further advantageous embodiment, the container closures are not symmetrical and in particular not rotationally symmetrical.

In a further advantageous embodiment, the apparatus has an evaluation device for evaluating at least one captured image, which device is suitable and intended to determine a rotational position of the container closure from the at least one captured image and in particular to determine a rotation of the container closure relative to an opening of the container. This evaluation device advantageously applies a method of the type described above for image evaluation.

The apparatus preferably has a comparison device which compares the two captured images with one another. From this comparison, the presence of foreign bodies on the container closure, for example water droplets, is preferably inferred.

The container closures are preferably screw closures, which are preferably screwed onto the opening of the container.

Further advantages and embodiments emerge from the accompanying drawing.

### BRIEF DESCRIPTION OF THE DRAWINGS

In the drawings:

FIG. 1 shows a schematic representation of an apparatus according to the invention.

### DETAILED DESCRIPTION OF THE INVENTION

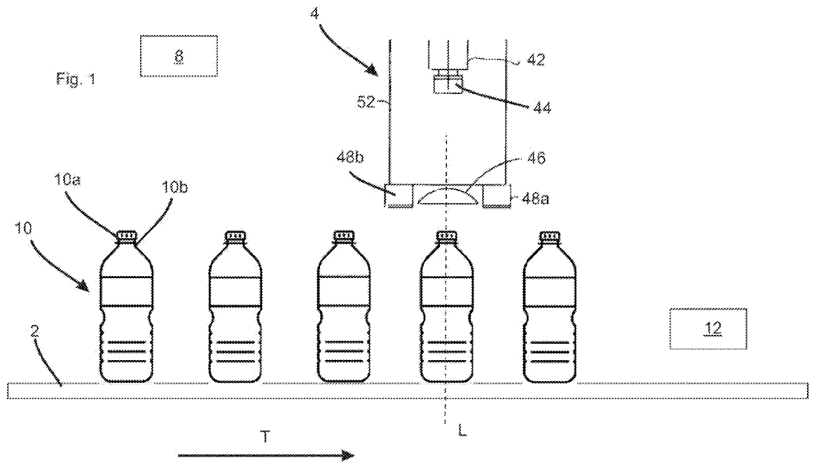

FIG. 1 shows an apparatus 1 according to the invention for inspecting containers 10. These containers 10 each have a container closure 10a, which is screwed onto the container. Furthermore, a marking (not shown) is provided on the container closure (in particular a marking which is visible from above) and also a corresponding marking is formed on a support ring 10b of the container. A relative rotational position between the container closure and the marking can be determined by capturing an image of the container closure and this marking, and it can thus be determined whether the container closure is properly arranged on the container. The reference sign L designates the longitudinal direction of the container to be inspected.

The reference sign 4 designates an inspection device, which here has an image capture device 42 and an optical unit 44. This image capture device is arranged, in relation to a longitudinal direction L, above the container 10 in order to inspect said container.

The reference sign 46 designates an advantageously present optical device and in particular a lens device which is used to observe the container closure 10a. Preferably, this lens device has a significantly larger diameter than the object to be observed, and than the closure and the support ring of the container.

The reference signs 48a and 48b designate two illumination devices, which, in this embodiment, are arranged laterally next to the longitudinal direction L of the container. In this way, the container closure is illuminated obliquely from above.

To carry out the method according to the invention, for example, a first image can be captured, wherein here the illumination device 48a illuminates the container, and a second image can be captured, wherein the illumination device 48b illuminates the container. In this way, water droplets located on the container closure, for example, can be detected more easily.

In this case, it is possible for these illumination devices to output different light, for example light of different wavelengths. Furthermore, it would also be possible for different illumination angles to be selected for the two illuminations. Thus, for example, the first illumination (for the first image) could be designed as coaxial frontlight illumination, and the second illumination (for the second image) could be designed as flat ring light illumination.

The reference sign 52 designates a housing into which the image capture device 42 is integrated. This housing 52 can preferably be designed to absorb light on its inner walls.

The reference sign 12 designates an ejection device which is suitable and intended to eject out of the transport path containers which have been detected as defective or as defectively closed.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1-11. (canceled)

12. A method for inspecting containers, wherein containers provided with container closures are transported by a transport device along a predetermined transport path and inspected by means of a first inspection device during this transport, wherein the inspection device captures at least one first image of at least the container closure of a container by means of an image capture device,
wherein
a second image of at least this container closure is captured by means of an image capture device, wherein a time interval between the capture of the first image and of the second image being less than 10 ms.

13. The method according to claim 12,
wherein
the first image and the second image are compared with one another.

14. The method according to claim 12,
wherein
the first and the second image are captured by the same image capture device.

15. The method according to claim 12,
wherein
the first image is captured using first physical parameters, and the second image is captured using second physical parameters, and at least one parameter of the first physical parameters differs from at least one parameter of the second physical parameters.

16. The method according to claim 15,
wherein
the physical parameters are selected from a group of parameters which contains a time of the image capture, a duration of the image capture, a color of illumination, an illumination type, a filter setting, an observation angle of the image capture device, a distance of the observation device from the container closure, a polarization of the illuminating radiation, a directivity of the illuminating light, and the like.

17. The method according to claim 12,
wherein
the container closures are inspected using the frontlight method.

18. The method according to claim 12,
wherein
an opening region of the container is also captured with the first image and/or the second image.

19. The method according to claim 12,
wherein
at least one of the captured images is evaluated, in order to infer a rotational position of the container closure relative to the container.

20. An apparatus for inspecting containers provided with container closures, comprising a transport device which transports the containers along a predetermined transport path and comprising an inspection device for inspecting the containers, the inspection device having a first image capture device which captures at least one image of a container provided with a container closure,
wherein
the inspection device configured to capture at least one second image of this container provided with the container closure.

21. The apparatus according to claim 20,
wherein
the image capture device is arranged above the transport path of the containers.

22. The apparatus according to claim 20,
wherein
the apparatus has an evaluation device configured for evaluating at least one captured image, which device is configured to determine a rotational position of the container closure from the at least one captured image.
